(19) United States
(12) Patent Application Publication
(10) Pub. No.: US 2026/0085510 A1
(43) Pub. Date: Mar. 26, 2026

(54) DRAIN CLOG DETECTION

(71) Applicant: AER Solutions, LLC, Houston, TX (US)

(72) Inventors: Christopher M. MAGNUSON, Houston, TX (US); Frederick L MONTGOMERY, Houston, TX (US)

(21) Appl. No.: 19/265,555

(22) Filed: Jul. 10, 2025

Related U.S. Application Data
(60) Provisional application No. 63/699,364, filed on Sep. 26, 2024.

(51) Int. Cl. E03F 7/00; G01F 23/26

(52) U.S. Cl. CPC E03F 7/00; G01F 23/26

(57) ABSTRACT

A clog detection system with a sensing device that detects fluid in an upper portion of a first drain line with the sensing device disposed outside the first drain line. A clog detection system with a sensing device that detects an elevated level of fluid in a backup drain pan or drain line with the sensing device removably attached to a support structure and removably attached to a backup drain pan or a drain line. A clog detection system with a support structure that removably attaches a sensing device to a branch tailpiece having a main body with a first center axis and a branch with a second center axis, where the support structure aligns the sensing device parallel with the second center axis and aligns a sensing field of the sensing device with a plane formed by the first center axis and the second center axis.

### FIELD OF THE DISCLOSURE

The present invention relates, in general, to safety systems for dwelling places. More particularly, present embodiments relate to a system and method for detecting when a clog is present in a drainage system.

### BACKGROUND

Drainage systems in dwelling places (e.g., residential homes, commercial buildings, apartments, condos, recreational vehicles, etc.) are used to remove wastewater and waste material from the dwelling space and flow it into an external sewer system. As long as the plumbing in the drainage system remains clear of obstructions, the removal of the wastewater and waste material from the dwelling space can continue unimpeded. However, when obstructions occur, the drainage system may not function correctly and can cause overflow of the wastewater or waste material into the dwelling place. Depending upon the amount of overflow and where the overflow occurs, very costly repairs to the dwelling place can be the result of the overflow or spillage. Additionally, if the occupants of the dwelling place are not present at the time of the overflow, or are otherwise distracted, the overflow can continue unchecked thereby increasing the damage to the dwelling place. Therefore, improvements in drainage systems are continually needed.

### BRIEF DESCRIPTION OF THE DRAWINGS

Embodiments are illustrated by way of example and are not limited to the accompanying figures. These and other features, aspects, and advantages of present embodiments will become better understood when the following detailed description is read with reference to the accompanying drawings in which like characters represent like parts throughout the drawings, wherein:

FIG. 1 is a representative partial cross-sectional view of a drainage system for a dwelling place that utilizes sensors for detecting a clog in the drainage system, in accordance with certain embodiments;

FIGS. 2A-3B are representative partial cross-sectional views of possible configurations of a sensing device that can be used to detect presence of a clog in a drainage system, in accordance with certain embodiments;

FIG. 4A is a representative perspective view of a drainage system for a sink, in accordance with certain embodiments;

FIG. 4B is a representative partial cross-sectional view of a drainage system for the sink with a branch tailpiece that receives fluid from the sink and a drain line, in accordance with certain embodiments;

FIG. 4C is a representative perspective view of a sensing device configured to attach to a branch tailpiece, in accordance with certain embodiments;

FIG. 4D is a representative partial cross-section top view of a support structure of a sensing device that is configured to attach to a branch tailpiece, in accordance with certain embodiments;

FIGS. 5A and 5B are representative partial cross-sectional side views of a drainage system for a sink, with the drainage system being clogged, in accordance with certain embodiments;

FIG. 6 is a representative side view of a drainage system for a sink with a sensing device attached to a branch tailpiece that receives fluid from the sink and a drain line, in accordance with certain embodiments;

FIGS. 7A-7B are representative partial cross-sectional views 7A-7A, as indicated in FIG. 6, of a sensing device attached to a branch tailpiece with various levels of fluid therein, in accordance with certain embodiments;

FIG. 7C is a representative partial cross-sectional view, of a sensing device attached to a branch tailpiece or drain line, in accordance with certain embodiments;

FIG. 7D is a representative partial cross-section top view of a support structure of a sensing device that is configured to attach to a branch tailpiece, in accordance with certain embodiments;

FIGS. 8A and 8B are representative perspective views of a sensing device configured to attach to a drain line with or without insulation, in accordance with certain embodiments;

FIGS. 9A and 9B are representative partial cross-sectional views 9A-9A, as indicated in FIG. 8A, of a sensing device attached to a drain line with various levels of fluid therein, in accordance with certain embodiments;

FIG. 10 is a representative perspective view of a sensing device configured to attach to a backup drain pan for a heating, ventilation, and air conditioning (HVAC) system, in accordance with certain embodiments;

FIGS. 11A and 11B are representative partial cross-sectional views 11A-11A, as indicated in FIG. 10, of sensing device attached to a backup drain pan for an HVAC system with various levels of fluid therein, in accordance with certain embodiments;

FIGS. 12, 13, and 14 are representative functional block diagrams of sensing devices being used to monitor and manage a drainage system for a dwelling place and control an HVAC system based on the indications from the sensing devices, in accordance with certain embodiments;

FIGS. 15 and 16 are representative functional block diagrams of sensing devices being used to monitor and manage a drainage system in a dwelling place and notify a user based on the indications from the sensing device, in accordance with certain embodiments;

FIG. 17 is a representative partial cross-sectional view of sensing devices being used to monitor and manage a sump pump operation in a drainage system in a dwelling place, in accordance with certain embodiments; and

FIG. 18 is a representative functional block diagram of sensing devices being used to monitor and manage a sump pump operation in a drainage system in a dwelling place and notify a user based on the indications from the sensing device, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

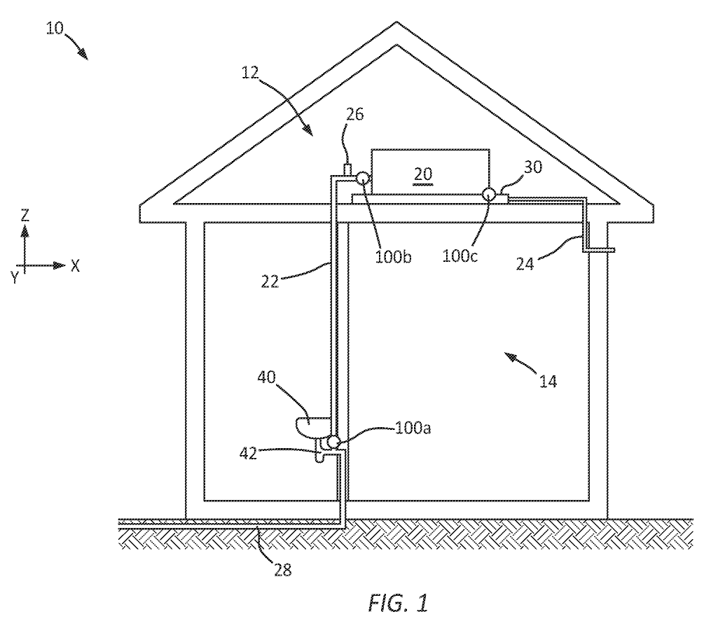

FIG. 1 is a representative partial cross-sectional view of a drainage system 12 for a dwelling place 10 with a clog detection system 14 that can utilize sensing devices 100a, 100b, 100c for detecting a clog in the drainage system 12, in accordance with certain embodiments. In this example, a dwelling place 10 (e.g., a residential home) can include an HVAC system 20 which can remove moisture vapor from the air that blows across cooling coils in the HVAC system 20. The moisture vapor can condense on the cooling coils and run down the cooling coils into a catch basin in the HVAC system 20. A drain line 22 (or conduit) with a cleanout 26 can be connected to the HVAC system 20 to drain fluid from the catch basin as the HVAC system 20 continues to condense the water vapor on the cooling coils.

Some HVAC systems 20 can produce 20 gallons of water per day. If the drainage system 12 has one or more obstructions that prevent adequate removal of the water from the dwelling place, then overflow or spillage in the dwelling place can occur. The current disclosure describes sensing devices 100a, 100b, 100c that can monitor fluid levels in the drainage system 12 and alert someone to a clog in the drainage system 12 or automatically halt operation of a fluid source to minimize any impacts to the dwelling place 10 from the clog.

The sensing device 100a can be positioned at a connection of the drain line 22 to a sink drain 42 of a sink 40 (e.g., a branch tailpiece), where the fluid from the HVAC system 20 can drain into the sink drain 42 and then out through sewer drain 28. This sensing device 100a can detect clogs in the drainage system 12 that may not be detected by sensors at a higher elevation, such as sensing devices 100b, 100c.

FIG. 1 shows the sensing device 100a being used to detect when fluid from the HVAC system 20 may back up into the sink drain 42. The detection of fluid backing up in the sink drain 42 can be used to notify users or halt operation of the HVAC system 20. However, other systems, such as a dishwasher, a sump pump, etc. can drain into the drain pipe 42 and their operation can be halted when standing fluid is detected in the sink drain 42.

A sensing device 100b can be used to detect if a clog has occurred in the drain line 22 above the sink drain 42. If a clog occurs in the sink drain 42, then fluid flowing from the HVAC system 20 through the drain line 22 to the sink drain 42 can simply run out on the floor by overflowing the sink 40. However, clogs in the drain line 22, which can be upstream of the sink drain 42, can be detected by the sensing device 100b.

A sensing device 100c can be used to detect if a clog occurs in a drain line 24 that can cause fluid to build up in a backup drain pan 30 of the HVAC system 20. The backup drain pan 30 can collect overflow fluid from the HVAC system 20 when a clog or other failure has occurred in the HVAC system 20 to prevent fluid from being properly drained from the HVAC system 20 through the drain line 22. The fluid can be drained from the backup drain pan 30 through the drain line 24 which can expel the fluid to an external environment outside the dwelling place 10. However, if a clog occurs in the drain line 24, then the sensing device 100c can detect a build up of fluid in the backup drain pan 30 and can be used to halt operation of the HVAC system 20 or notify users.

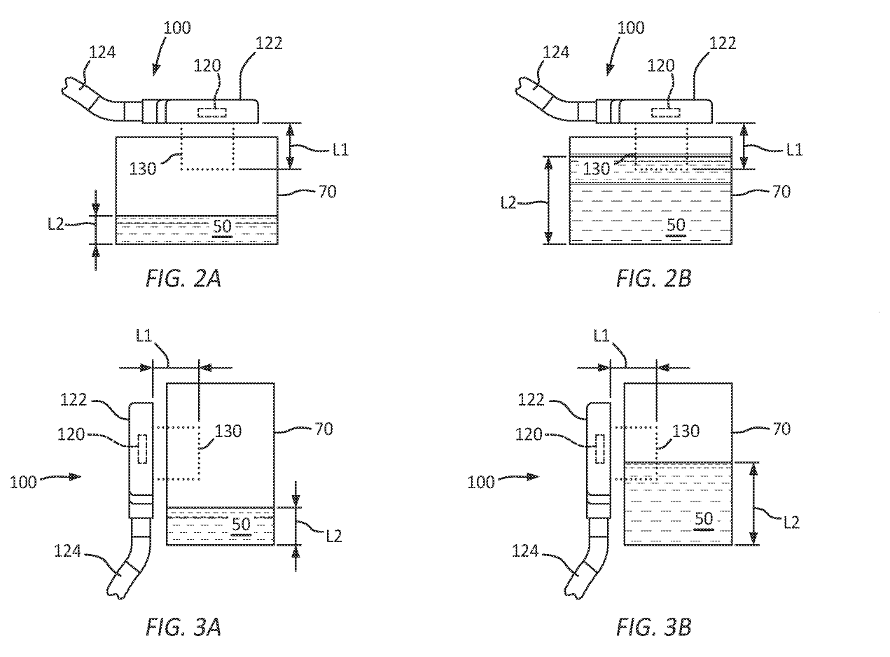

FIGS. 2A-2B are representative partial cross-sectional views of a configuration of a sensing device 100 that can be used to detect a presence of a clog in a drainage system 12, in accordance with certain embodiments. The sensing device 100 can be positioned in a horizontal orientation proximate a top of a container 70 (e.g., a branch of a branch tailpiece, a drain line, a drain pan, etc.) such that a sensing field 130 of the sensing device 100 extends through a wall of the container 70 and into an uppermost region of the container 70. The sensing device 100 can include a sensor 120 (e.g., a capacitive sensor, etc.) that can generate the sensing field 130 that extends from the sensor 120 by a distance L1. A sensitivity of the sensor 120 can be adjusted such that it does not detect a wall of the container 70 and only detects the fluid 50 when the fluid level in the container 70 rises into the sensing field 130.

The sensor 120 can be a capacitive sensor that detects objects located in its sensing (or measurement) field by generating an electrical alternating field. Unlike inductive sensors, which produce an electromagnetic field, capacitive sensors produce an electrostatic field. When an object interacts with this field, the sensor measures the change in capacitance and reports it back to a receiver. The sensor can identify any object that interrupts its electrical field.

The sensing device 100 can include control lines 124 that provide power to the sensor 120 and transmit a signal that is representative of the detection of the sensor 120 to control a state of a switch (or to a controller to control one or more pieces of equipment or to send alerts). The sensing device 100 can also include a body 122 that can be used to house the sensor 120 and provide structural support for attaching the sensing device 100 to the container 70.

FIG. 2A shows the level L2 of the fluid 50 in the container 70 to be below the sensing field 130 such that the sensor 120 does not detect fluid 50 in the sensing field 130. Therefore, the control signals 124 can transmit a signal that indicates that the fluid level L2 is below the sensing field 130.

FIG. 2B shows that the level L2 of the fluid 50 in the container 70 has risen to be within the sensing field 130 such that the sensor 120 detects fluid 50 in the sensing field 130. Therefore, the control signals 124 can transmit a signal that indicates that the fluid level L2 is within the distance L1 from the sensor 120. This can indicate that the drainage system 12 has a clog and the fluid 50 is building up in the container because of it.

FIGS. 3A-3B are representative partial cross-sectional views of a configuration of a sensing device 100 that can be used to detect a presence of a clog in a drainage system 12, in accordance with certain embodiments. The sensing device 100 can be positioned in a vertical orientation along a side of a container 70 (e.g., a drain line, a drain pan, etc.) such that a sensing field 130 of the sensing device 100 extends through a wall of the container 70 and into the left (or right) region of the container 70. The sensing device 100 can include a sensor 120 (e.g., a capacitive sensor, etc.) that can generate the sensing field 130 that extends from the sensor 120 by a distance L1. A sensitivity of the sensor 120 can be adjusted such that it does not detect a wall of the container 70 and only detects the fluid 50 when the fluid level in the container 70 rises into the sensing field 130.

The control lines 124 provide power to the sensor 120 and transmit a signal representative of the detection of the sensor 120 to control a state of a switch (or to a controller to control one or more pieces of equipment or to send alerts). The sensing device 100 can also include a body 122 that can be used to house the sensor 120 and provide structural support for attaching the sensing device 100 to the container 70.

FIG. 3A shows the level L2 of the fluid 50 in the container 70 to be below the sensing field 130 such that the sensor 120 does not detect fluid 50 in the sensing field 130. Therefore, the control signals 124 can transmit a signal that indicates that the fluid level L2 is below the sensing field 130.

FIG. 3B shows that the level L2 of the fluid 50 in the container 70 has risen to be within the sensing field 130 such that the sensor 120 detects fluid 50 in the sensing field 130. Therefore, the control signals 124 can transmit a signal that indicates that the fluid level L2 is within the distance L1 from the sensor 120. This can indicate that the drainage system 12 has a clog and the fluid 50 is building up in the container because of it.

In the vertical orientation (or angled orientations from vertical), flow of fluid 50 downward in the container 70 during normal operation (i.e., no clog, fluid flowing normally) can cause the sensor 120 to detect the presence of fluid 50 in the sensing field 130. Therefore, the detection signal from the sensor 120 can be sent to a controller that can determine how long the sensor 120 is indicating fluid detection, and if the time frame is below a predetermined time period, then the controller can determine that the detections are normal flow. However, if the time frame is longer than the predetermined time period, then the controller can determine that the detections can indicate that a clog exists.

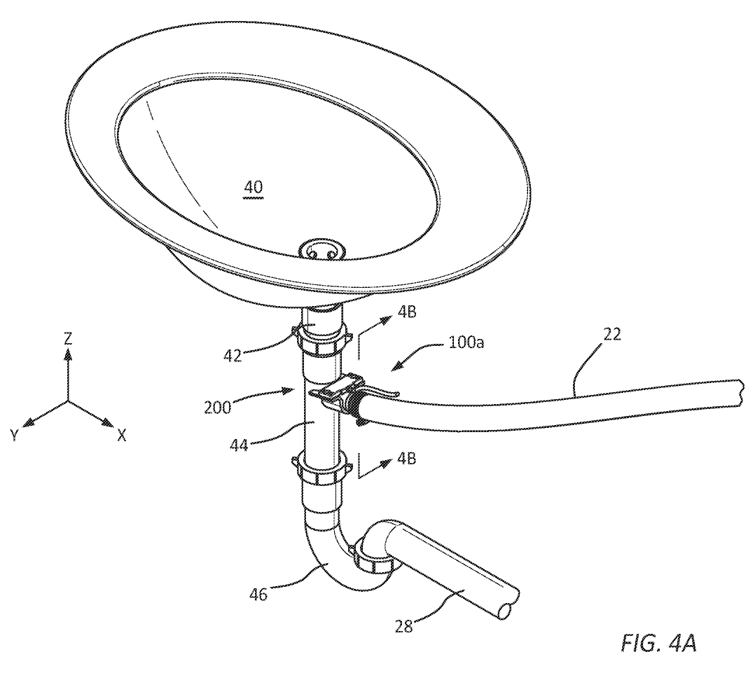

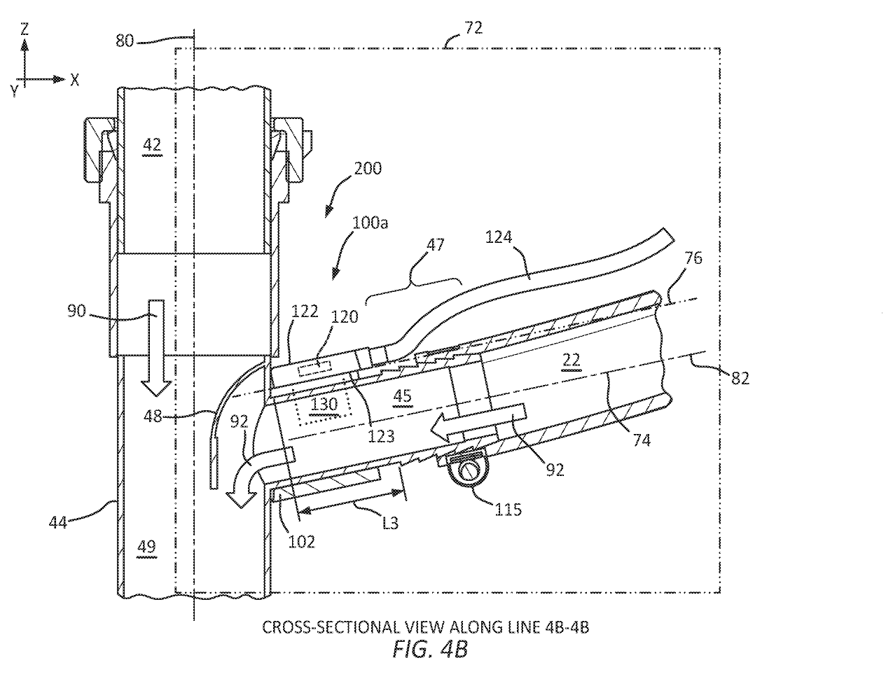

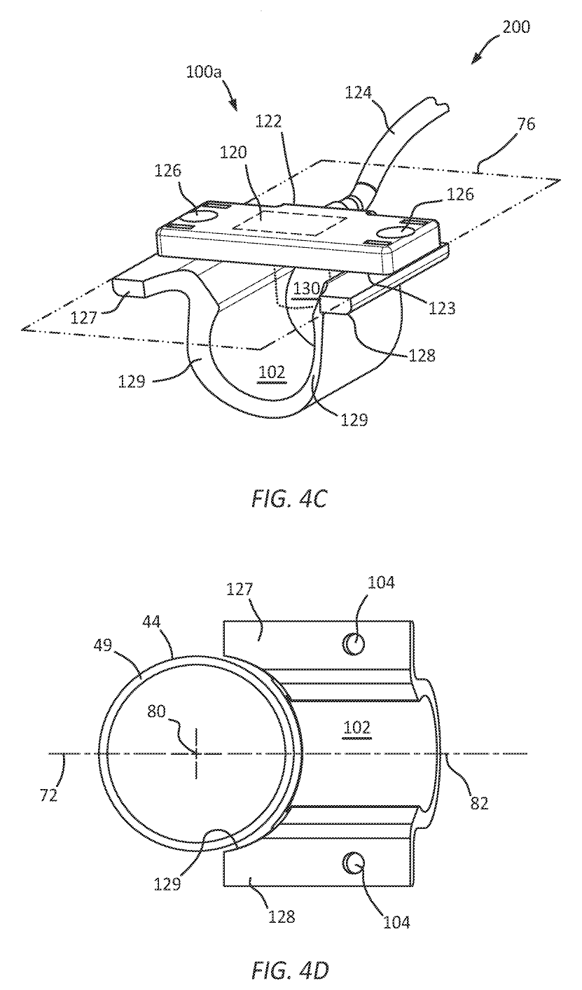

FIG. 4A is a representative perspective view of a drainage system for a sink 40, in accordance with certain embodiments. The drainage system can include a sink drain 42 that directs fluid from the sink 40 to the sewer drain 28 via a branch tailpiece 44 and a P-trap 46. The branch tailpiece 44 can receive fluid 50 from the sink drain 42 and from a drain line 22 via a branch 45 (see FIG. 4B) of the branch tailpiece 44. A sensing device 100a can be positioned at the junction of the branch 45 and the main body of the branch tailpiece 44. If a clog exists in the P-trap 46 or further downstream in the sewer drain 28, fluid 50 can possibly buildup in the drainage system 12 such that fluid 50 rises into a sensing field 130 of the sensing device 100a. The sensing assembly 200 can include the sensing device 100a coupled to the support structure 102 via one or more fasteners 114.

FIG. 4B is a representative partial cross-sectional view of a drainage system for a sink 40 with a branch tailpiece 44 that receives fluid 50 from a drain line 22, in accordance with certain embodiments. Fluid flow 90 from the sink drain 42 can be directed down past the branch 45 and through the branch tailpiece 44. A diverter 48 can be used to divert the fluid flow 90 away from the branch 45 so it does not enter the branch 45. The diverter 48 can also direct the fluid flow 92 from the drain line 22 downward to minimize turbulence caused by merging the fluid flows 90, 92.

A sensing device 100a can be attached to the branch 45 where the branch 45 joins the main body of the branch tailpiece 44. It can be preferred that the sensing device 100a be mounted on the branch 45 between the barbs 47 (used to attach the drain line 22 to the branch 45 via a fastener 115) and a wall of the main body 49 of the branch tailpiece 44. However, the sensing device 100a can be restricted to fit within the distance L3 which is the distance from the barbs 47 and the wall of the main body 49 of the branch tailpiece 44. This limits that size of the sensing device 100a, if the sensing device 100a is to be positioned on the branch 45. Some benefits for mounting the sensing device 100a to the branch 45 is that the fluid 50 draining from the sink 40 does not cause false positives from the sensing device 100a because the diverter 48 directs the fluid 50 flowing from the sink 40 (arrows 90) away from the branch 45. Also, the sensing device 100a can provide the earliest warning that a clog has occurred. With the sensing device 100a positioned on the branch 45, it can provide more time for someone to react to an alert that a clog is detected or for a controller to shut off a water source to prevent spillage.

However, it should be understood that the sensing device 100 can be attached to the drain line 22 upstream from the branch 45. This can delay detection of a clog by the additional time it takes for the fluid level in the branch tailpiece 44 and drain line 22 to rise to the level of the sensing device 100a as compared to the sensing device 100a being positioned on the branch 45. However, the sensing device 100a should not be positioned such that it is elevated above the sink 40. It can be preferrable that the sensing device 100a be positioned enough downstream from the elevation of the top of the sink 40 to allow time for actions to be taken if an indication that a clog is detected.

Another benefit of the sensing device 100a being positioned at the junction of the branch 45 and the main body of the branch tailpiece 44 is that one or more registering features can be used to engage the main body of the branch tailpiece 44 to ensure that the sensor 120 of the sensing device 100 remains radially positioned at the top of the branch 45. The axis 80 and the axis 82 can form a plane 72 that can also be seen as an X-Z plane. The axis 82 and the Y-axis can form a plane 74 that extends into and out of FIG. 4B at the axis 82, where the plane 74 is perpendicular to the plane 72.

The body 122 of the sensing device 100a can have a bottom surface or a top surface 123 that generally forms a plane 76. The plane 76 can be parallel with the plane 74 and spaced away from the plane 74, when the sensing device 100a is mounted to the support structure 102. The support structure 102 can be used to register the sensing device 100a relative to the axes 80, 82, by positioning the sensing device 100a outside of the branch 45 such that the plane 76 is parallel with the axis 82. Also, by engaging the body 49, the support structure 102 can ensure that the plane 76 is perpendicular with the plane 72 and prevent rotation of the sensing device 100a about the axis 82.

FIG. 4C is a representative perspective view of a sensing device 100a configured to attach to the branch tailpiece 44, in accordance with certain embodiments. A support structure 102 can be formed to receive the branch 45 (or the drain line 22 in other configurations) and engage the support structure 102 with the branch 45 (or the drain line 22). The body 122 of the sensing device 100a can be configured to engage portions of the support structure 102 and be attached to the support structure 102 via fasteners (e.g., screws, tie-wraps, rivets, etc.) installed through the holes 126, or via glue disposed between the support structure 102 and the body 122, or mechanically engaged with each other. Holes 126 in the body 122 can align with the holes 104 in the support structure 102 to receive the fasteners. The sensing assembly 200 can include the sensing device 100a coupled to the support structure 102 via one or more fasteners 114.

FIG. 4D is a representative partial cross-section top view of the sensing device 100a configured to attach to the branch tailpiece 44, in accordance with certain embodiments. The support structure 102 can include a complimentarily shaped surface 129 that can follow an exterior contour of the main body 49 of the branch tailpiece 44 when the support structure 102 is attached to the branch 45. The complimentarily shaped surface 129 can extend to opposing protrusions 127, 128 that can straddle the main body 49 of the branch tailpiece 44. These protrusions 127, 128 that can be positioned on opposite sides of the main body 49 of the branch tailpiece 44 and can help to register the sensing device 100a when it is attached to the branch 45 such that the sensor 120 is positioned at a top of the branch 45. This can ensure that the sensing field 130 is monitoring the top region of the branch 45.

The support structure 102 can be used to register the sensing device 100a in a desired orientation relative to the center axis 80 of the body 49 and the center axis 82 of the branch 45. The support structure 102, when engaged with the branch 45, can center the branch 45 horizontally within the support structure 102 and position the sensing device 100a (when it is attached to the top of the support structure 102) at a desired vertical position above the branch 45. The desired vertical position can be such that the sensing field 130 extends a desired distance into the top of the branch 45. Additionally, the complimentarily shaped surface 129, including the opposing protrusions 127, 128, can act to prevent rotation of the support structure 102 around the branch 45, thereby ensuring that the sensing device 100a remains positioned at the desired vertical position above the branch 45. Therefore, the support structure 102 acts to orient the sensing device 100a at a desired position relative to the center axes 80, 82. Alternatively, or in addition, the sensor body 122 can be formed to engage the main body 49. The support structure 102 can be merely a bracket that secures, along with fasteners 114, the sensor body 122 to the branch 45. The engagement of the sensor body 122 with the main body 49 can prevent rotation of the sensor assembly 200 about the center axis 82 of the branch 45.

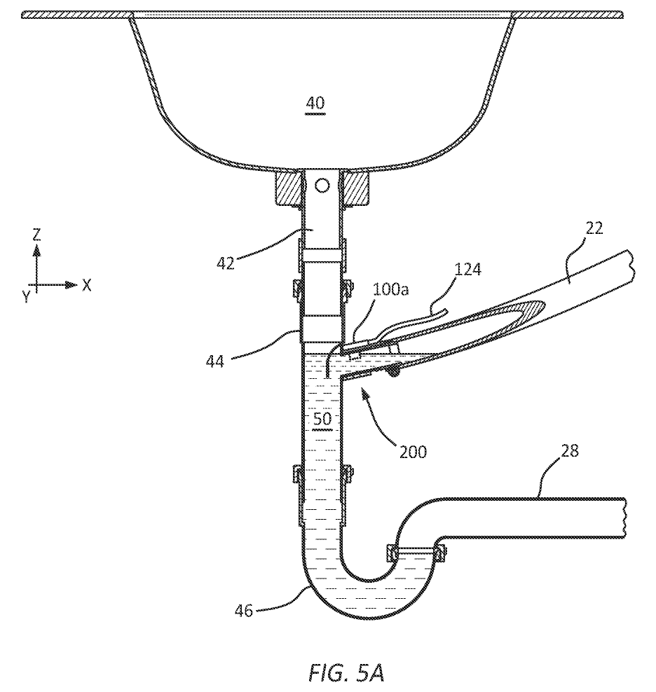

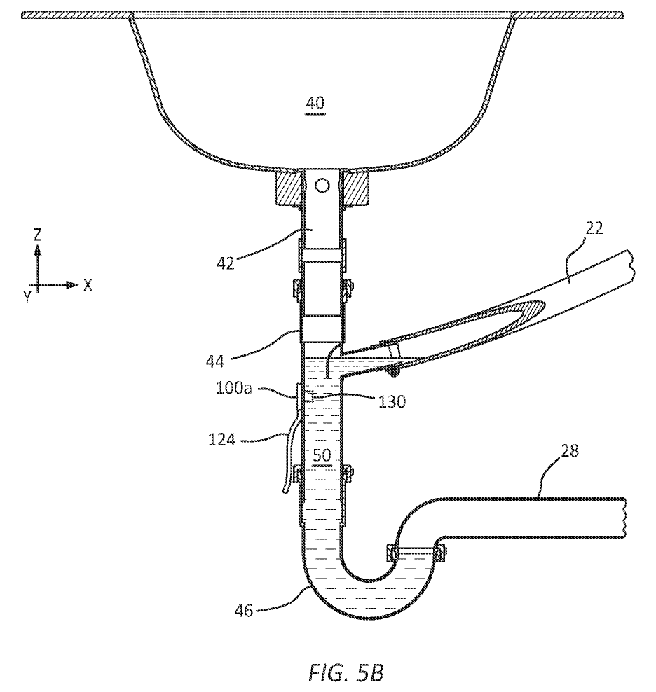

FIG. 5A is a representative partial cross-sectional side view of a drainage system for a sink 40, with the drainage system being clogged, in accordance with certain embodiments. The sensing device 100a can be mounted to the branch 45 as shown in FIGS. 4A and 4B. If a clog exists in the P-trap 46, then fluid 50 received from either the sink 40 or the drain line 22 (e.g., from an HVAC system, a dishwasher, a sump pump, etc.) can build up in the drainage system such that the fluid level rises into the sensing field 130 of the sensing device 100a. The sensing device 100a can send an indication to a person or to a controller that fluid 50 is detected in the branch 45 and a clog can be the cause. Corrective action can be taken before damage to the dwelling place 10 occurs. The sensing assembly 200 can include the sensing device 100a coupled to the support structure 102 via one or more fasteners 114.

FIG. 5B is a representative partial cross-sectional side view of a drainage system for a sink 40, with the drainage system being clogged, in accordance with certain embodiments. The sensing device 100 can be mounted to the branch as shown in FIGS. 3A and 3B. If a clog exists in the P-trap 46, then fluid 50 received from either the sink 40 or the drain line 22 (e.g., from an HVAC system, a dishwasher, a sump pump, etc.) can build up in the drainage system such that the fluid level rises into the sensing field 130 of the sensing device 100. The sensing device 100 can send an indication to a person or to a controller that fluid is detected in the branch 45 and a clog can be the cause. Corrective action can be taken before damage to the dwelling place 10 occurs.

In this configuration, false positives can be caused by normal fluid flow from the sink 40 (as well as possibly from the branch 45) since fluid 50 can consistently enter into the sensing field 130 of the sensing device 100 during normal drainage of the fluid 50. Therefore, the sensing device 100 (or a controller) can use a time delay to determine how long a positive indication of presence of the fluid 50 in the sensing field 130 occurs. If the sensing device 100 senses a continuous indication of the presence of the fluid 50 in the sensing field 130 for a time period longer than the time delay, then the sensing device 100 (or controller) can interpret this as confirmation that a clog exists and that the clog is causing the indication of the fluid 50 being present in the branch tailpiece 44 and not just normal drainage. It should be understood that filters other than a time delay can be used to minimize false positives from the sensing device 100, such as detecting a threshold capacitance when the sensing field 130 extends completely across the main body 49 of the branch tailpiece 44.

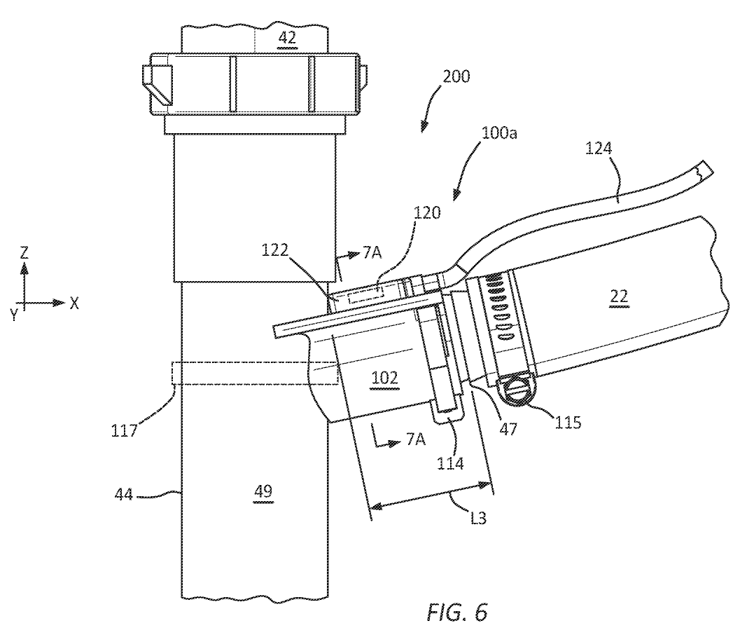

FIG. 6 is a representative side view of a drainage system for a sink 40 with a sensing device 100a attached to a branch tailpiece 44 that receives fluid 50 from the sink 40 and a drain line 22, in accordance with certain embodiments. The sensing device 100a of FIG. 6 is very similar to the sensing device 100a shown in FIGS. 4A-4D, except that the support structure 102 is not a clamping body that clamps to the branch 45 of the branch tailpiece 44. The support structure 102 can engage the branch 45, but it does not clamp the branch 45. The support structure 102 can be secured to the branch 45 via one or more fasteners 114 or secured to the main body 49 via one or more fasteners 117. The one or more fasteners 117 can be used in addition to the one or more fasteners 114 or as an alternative to the one or more fasteners 114. The sensing assembly 200 can include the sensing device 100a coupled to the support structure 102 via one or more fasteners 114.

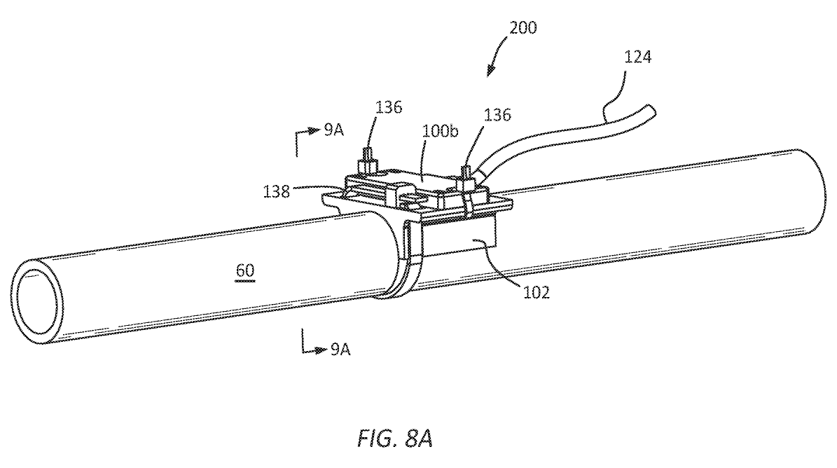

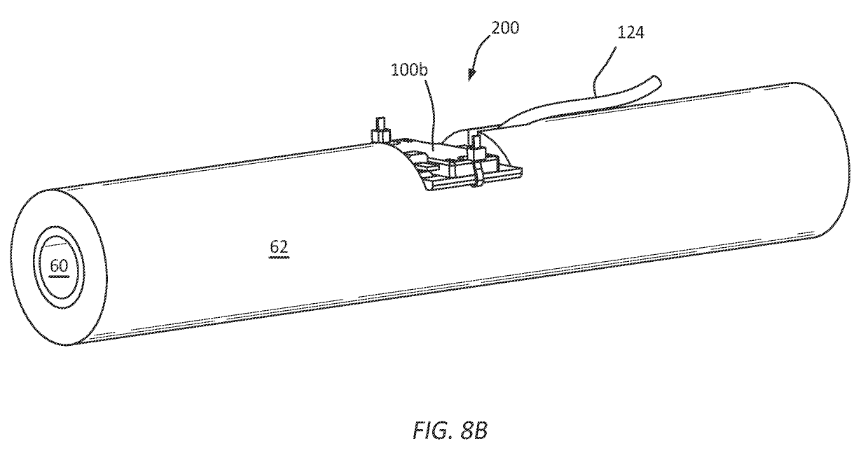

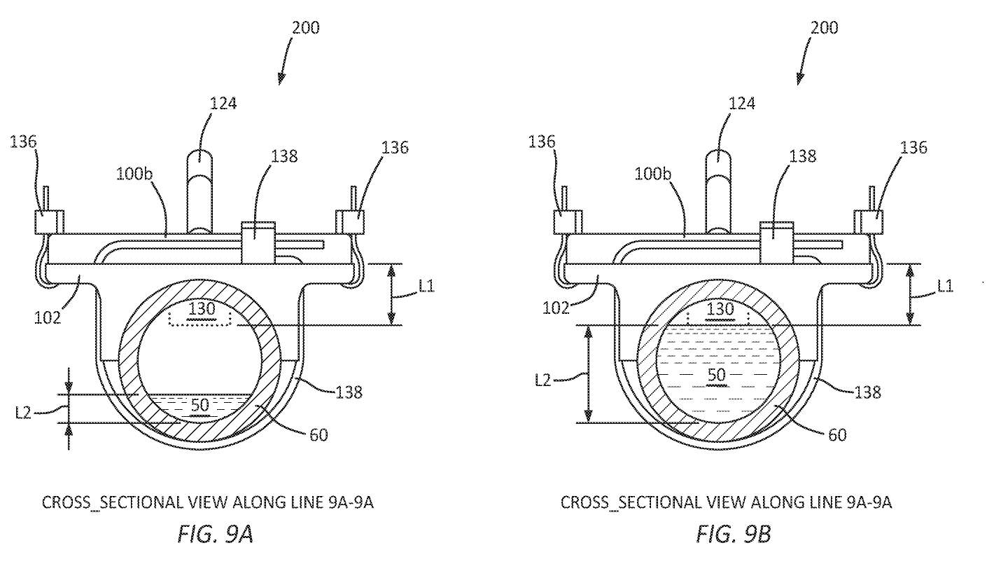

It should be understood that the support structure 102 of FIG. 6 can also be configured as shown in FIGS. 8A-9B, where the support structure 102 is mounted on top of the branch 45 with the sensing device 100a mounted on top of the support structure 102. One or more fasteners 114 or 117 can be used to secure the support structure 102 to the branch tailpiece 44. The support structure 102 can also include a complimentarily shaped surface 129 with opposing protrusions 127, 128 that can orient the sensing device 100a as desired relative to the axes 80, 82 of the main body 49 and the branch 45, respectively.

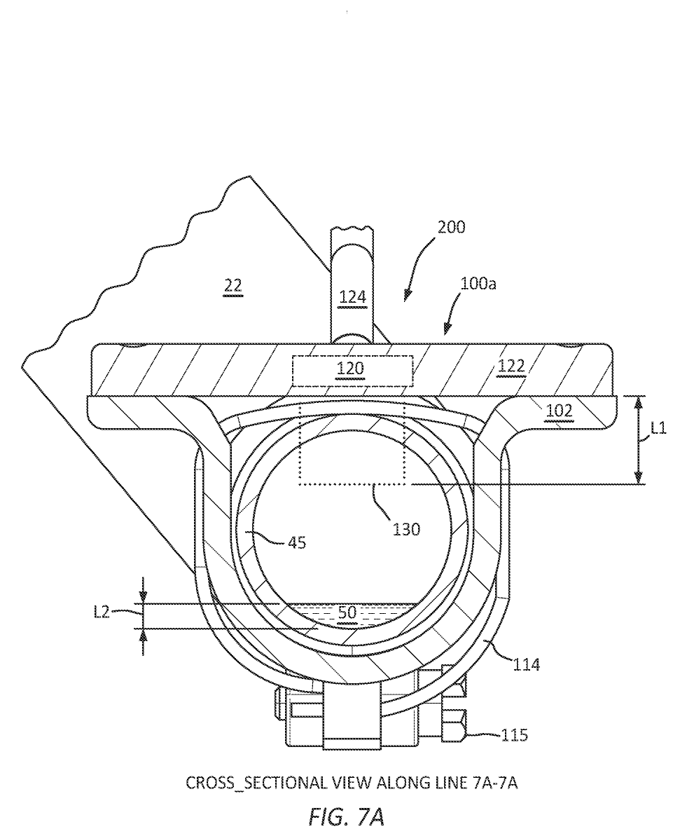

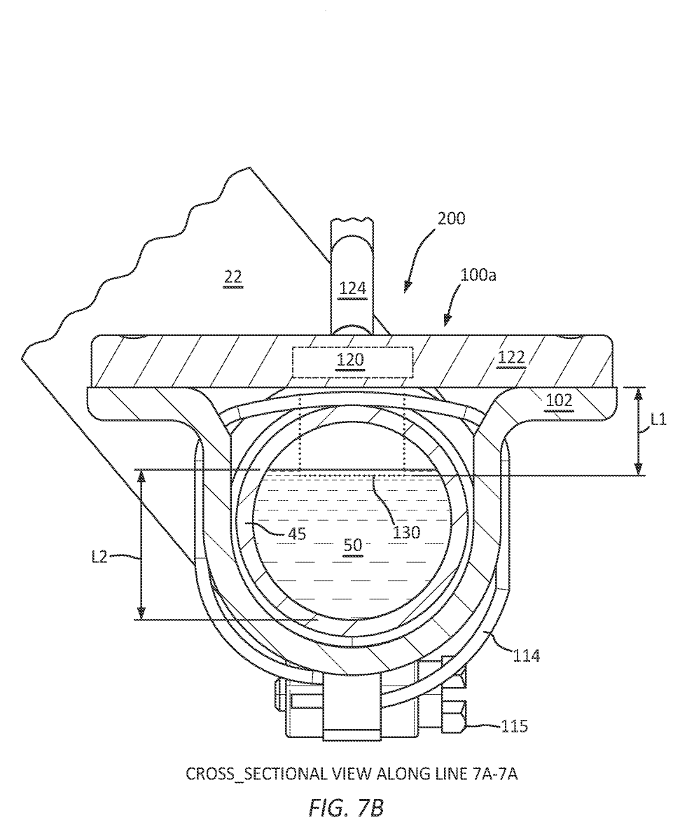

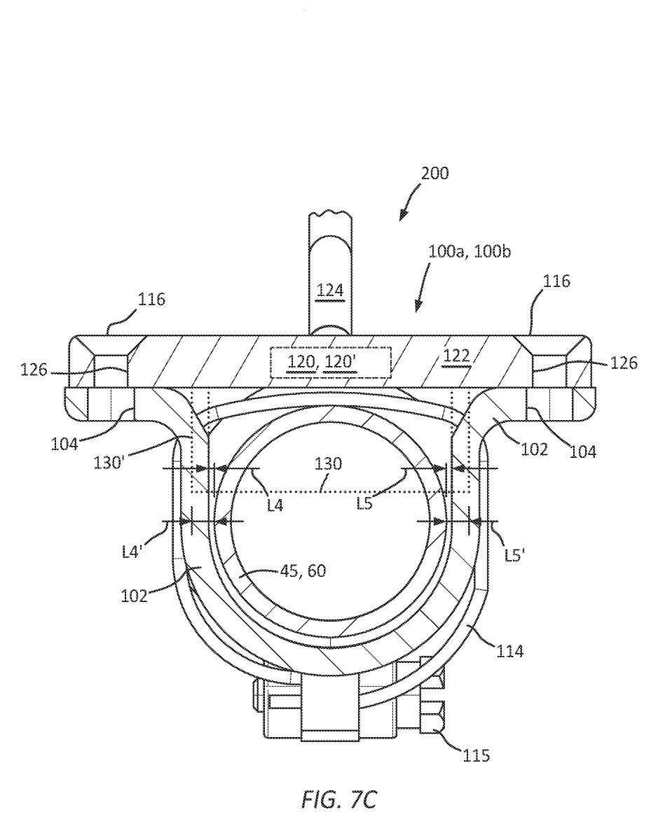

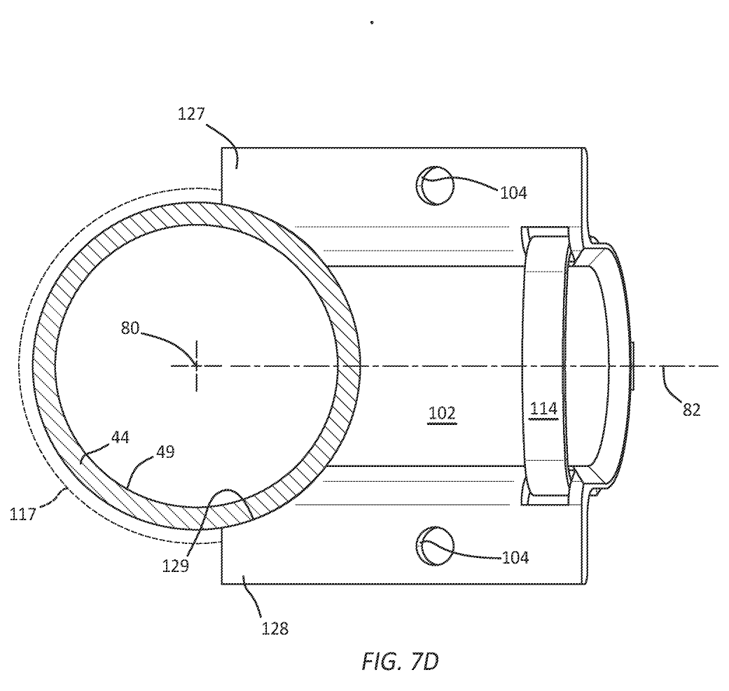

FIGS. 7A-7B are representative partial cross-sectional views 7A-7A, as indicated in FIG. 6, of a sensing device 100a attached to a branch tailpiece 44 with various levels of fluid therein, in accordance with certain embodiments. The sensing field 130 can extend from the sensing device 100a by the distance L1 which is configured to extend into the top portion of the branch 45. In normal operations, the fluid 50 can be flowing through the branch 45 at a level L2, which in FIG. 7A is well below the sensing field 130. Therefore, the sensing device 100a can indicate to a controller or a person that operations are normal, and no clog exists.

However, if the fluid level L2 rises into the sensing field 130, then the sensing device 100a can indicate to a controller (or a person) that operations are not normal, and a clog may exist. Corrective action can be taken to halt operation of particular systems (e.g., HVAC system, dishwasher, sump pump, etc.) to stop adding more fluid to the branch 45.

FIG. 7C is a representative partial cross-sectional view of a sensing device 100a attached to a branch tailpiece 44, in accordance with certain embodiments. FIG. 7C is also a representative partial cross-sectional view of a sensing device 100b attached to a drain line 60 (e.g., a drain line 60 in FIG. 8A), in accordance with certain embodiments. As can be seen in these non-limiting embodiments, the support structure 102 can be formed such that there is a gap L4 on the left side (as viewed in cross-section) between the support structure 102 and the branch 45 (or drain line 60) and a gap L5 on the right side (as viewed in cross-section) between the support structure 102 and the branch 45 (or drain line 60). In these embodiments, the support structure 102 does not clamp to branch 45 or drain line 60. Support structure 102 can be held in place by an operator while a fastener 114 is applied to secure the support structure 102 to the branch 45 or drain line 60. In a non-limiting embodiment, the sensor body 122 of the sensing device 100a can be suspended above the branch 45 via fasteners 116 applied through the holes 126 in the body 122 and complementary holes 104 in the support structure 102. The sensing field 130 can be extended into the top portion of the branch 45 to detect when the fluid 50 has risen to an unacceptable level in the branch 45. In a non-limiting embodiment, the sensor body 122 of the sensing device 100b can be suspended above the drain line 60 via fasteners 116 applied through the holes 126 in the body 122 and complementary holes 104 in the support structure 102. The sensing field 130 can be extended into the top portion of the drain line 60 to detect when the fluid 50 has risen to an unacceptable level in the drain line 60.

The gaps L4, L5 can be sized to prevent portions of the support structure 102 from being positioned within the sensing field 130 of the sensor 120. In some embodiments, the presence of a portion of the support structure 102 within the sensing field 130 can cause false positives to be generated by the sensing system 200, so it can be advantageous to prevent portions of the support structure from being positioned within the sensing field 130. Therefore, the support structure 102 can be designed to increase or decrease the gaps L4, L5 to accommodate various sizes of sensing fields 130.

For example, if the sensing system 200 included a sensor 120’ with a sensing field 130’ (which is shown larger than the sensing field 130 of the sensor 120), the support structure 102 can be built to provide gaps L4’, L5’ between the branch 45 (or drain line 60) and the support structure 102. It should be understood that the cross-sectional shape of the support structure 102 can be modified to any shape that engages the branch 45 (or drain line 60) and provides the desired gaps L4’, L5’ to accommodate the sensing field 130’. It can be desirable, as stated above, the prevent any portion of the support structure 102 from being positioned within the sensing field 130’.

FIG. 7D is a representative partial cross-section top view of a support structure 102 of a sensing device 100a that is configured to attach to a branch tailpiece 44, in accordance with certain embodiments. The support structure 102 can be disposed on the branch 45 to be in parallel with the axis 82, which is angled from the axis 80 of the main body 49 of the branch tailpiece 44.

The support structure 102 can be used to register the sensing device 100a (not shown for clarity) in a desired orientation relative to the center axis 80 of the body 49 and the center axis 82 of the branch 45. The support structure 102, when engaged with the branch 45 and secured to the branch 45 via the fastener(s) 114, can center the branch 45 horizontally within the support structure 102 and position the sensing device 100a (when it is attached to the top of the support structure 102) at a desired vertical position above the branch 45. The desired vertical position can be such that the sensing field 130 extends a desired distance into the top of the branch 45.

Additionally, the complimentarily shaped surface 129, including the opposing protrusions 127, 128, can act to prevent rotation of the support structure 102 around the branch 45, thereby ensuring that the sensing device 100a remains positioned at the desired vertical position above the branch 45. Therefore, the support structure 102 acts to orient the sensing device 100a at a desired position relative to the center axes 80 and 82.

FIGS. 8A and 8B are representative perspective views of a sensing device configured to attach to a drain line 60 with or without insulation 62, in accordance with certain embodiments. FIG. 8A shows a sensing device 100b mounted to a support structure 102 (such as with fasteners 136) that is mounted to the drain line 60 (such as via a fastener 138). The sensing device 100b can be preferably mounted radially positioned on the drain line 60 approximately at the top. This can ensure that the sensing field 130 monitors the uppermost region in the internal flow passage of the drain line 60. This configuration can be used as described above in locations where the drain line 60 is generally horizontally oriented. However, as shown in FIGS. 4A and 4B, the sensing device 100 can operate satisfactorily in orientations that are angled from horizontal.

The bottom of the support structure 102 can follow the rounded contour of the drain line 60 to engage the rounded surface of the drain line 60. However, it is not required that the support structure 102 follow the rounded contour of the drain line 60. Holes in the support structure 102 can receive a fastener 138 to secure the support structure 102 to the drain line 60. The top of the support structure 102 can provide a platform on which the sensing device 100b can be mounted via fasteners 136 (e.g., screws, tie-wraps, rivets, etc.). FIG. 8B shows an insulation 62 applied to the drain line 60 with a portion removed to allow for mounting the sensing device 100b.

FIGS. 9A and 9B are representative partial cross-sectional views 9A-9A, as indicated in FIG. 8A, of sensing device 100b attached to a drain line 60 with various levels of fluid 50 therein, in accordance with certain embodiments. The sensing field 130 can extend from the sensing device 100b by the distance L1 which is configured to extend into the top portion of the drain line 60. In normal operations, the fluid 50 can be flowing through the drain line 60 at a level L2, which, in FIG. 9A is well below the sensing field 130. Therefore, the sensing device 100b can indicate to a controller or a person that operations are normal, and no clog exists.

However, if the fluid level L2 rises into the sensing field 130, then the sensing device 100b can indicate to a controller (or a person) that operations are not normal, and a clog may exist. Corrective action can be taken to halt operation of particular systems (e.g., HVAC system, dishwasher, sump pump, etc.) to stop adding more fluid to the drain line 60.

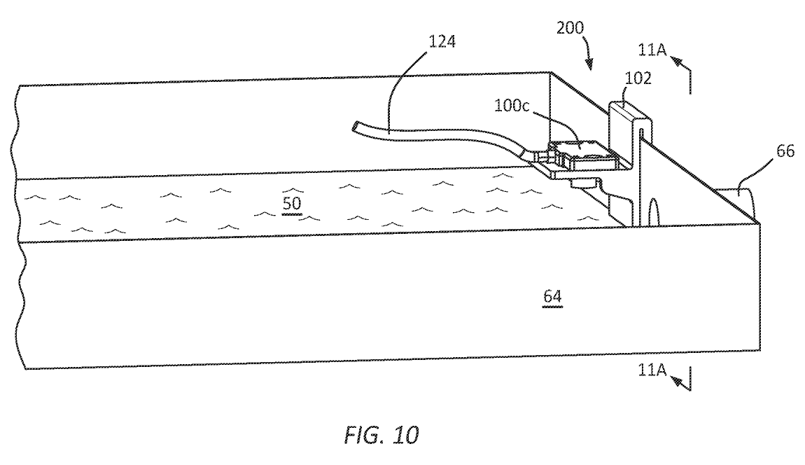

FIG. 10 is a representative perspective view of a sensing device 100c configured to attach to a backup drain pan 64, such as for a HVAC system 20, in accordance with certain embodiments. However, it should be understood that the sensing device 100c can be used in other drain pans other than HVAC systems 20. A support structure 102 can be formed to engage a side of the drain pan 64 and provide a shelf on which the sensing device 100c can be mounted. It is preferred that the sensing field 130 be extended below the sensing device 100c to detect when fluid 50 has risen to an undesirable level in the drain pan 64.

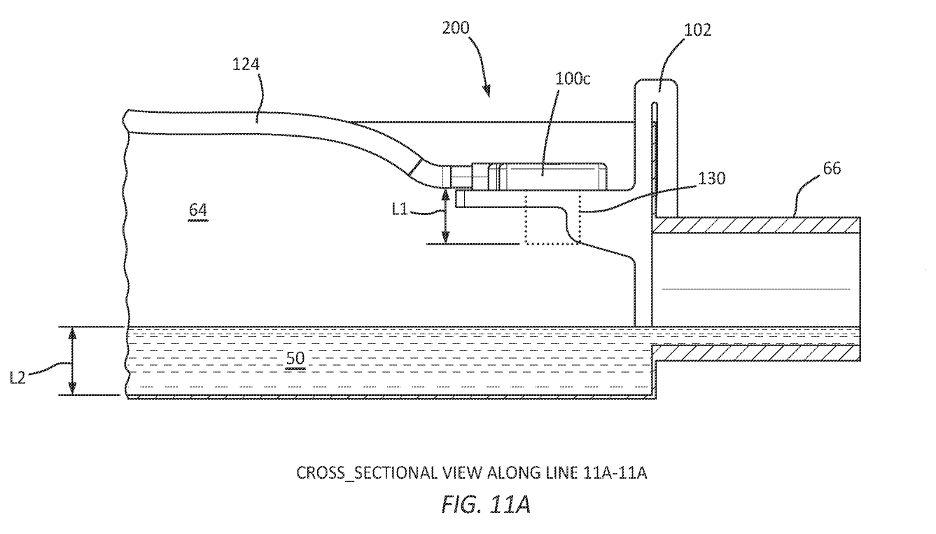

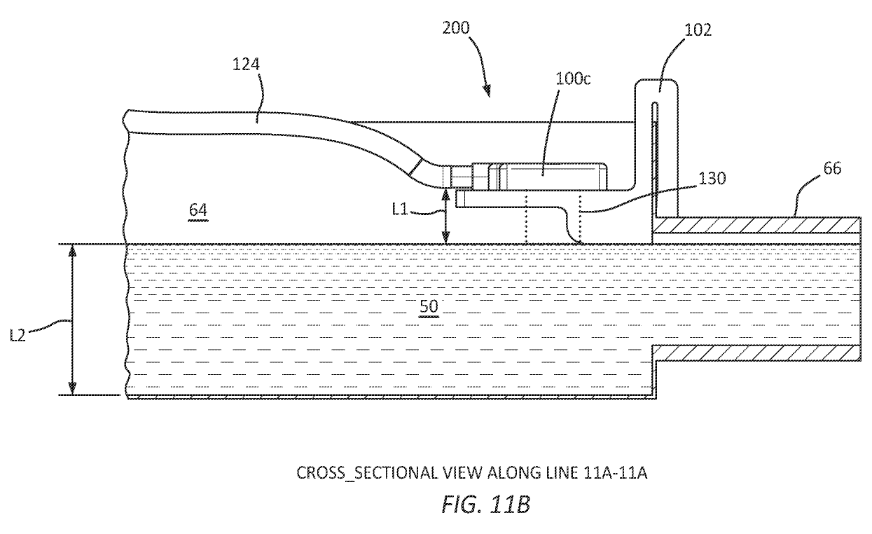

FIGS. 11A and 11B are representative partial cross-sectional views 11A-11A, as indicated in FIG. 10, of sensing device 100c attached to a backup drain pan 64 with various levels of fluid 50 therein, in accordance with certain embodiments. The sensing field 130 can extend from the sensing device 100b by the distance L1 which is configured to extend below the support structure 102. In normal operations, the backup drain pan 64 should not have fluid 50 collected in the pan 64. However, if the drain line 66 is properly flowing the fluid 50 from the backup drain pan 64 to the drain line 24, then the drainage system 12 is not necessarily in danger of overflowing the backup drain pan 64. Therefore, the sensing device 100c can indicate to a controller or a person that operations are normal, or at least no clog exists in the drain line 24 connected to the drain line 66.

However, if the fluid level L2 rises into the sensing field 130, then the sensing device 100c can indicate to a controller (or a person) that operations are not normal, and a clog may exist in the drain line 24. Corrective action can be taken to halt operation of particular systems (e.g., HVAC system, water heater, etc.) to stop adding more fluid 50 to the backup drain pan 64.

In each of these embodiments, the sensing devices 100a, 100b, 100c can be used to detect when the fluid 50, in parts of the drainage system 12, rises to an unacceptable level. The sensing devices 100a, 100b, 100c can indicate whether or not the fluid 50 is above or below the predetermined level and communicate this to a resident, an operator, a technician, or a controller to initiate corrective action.

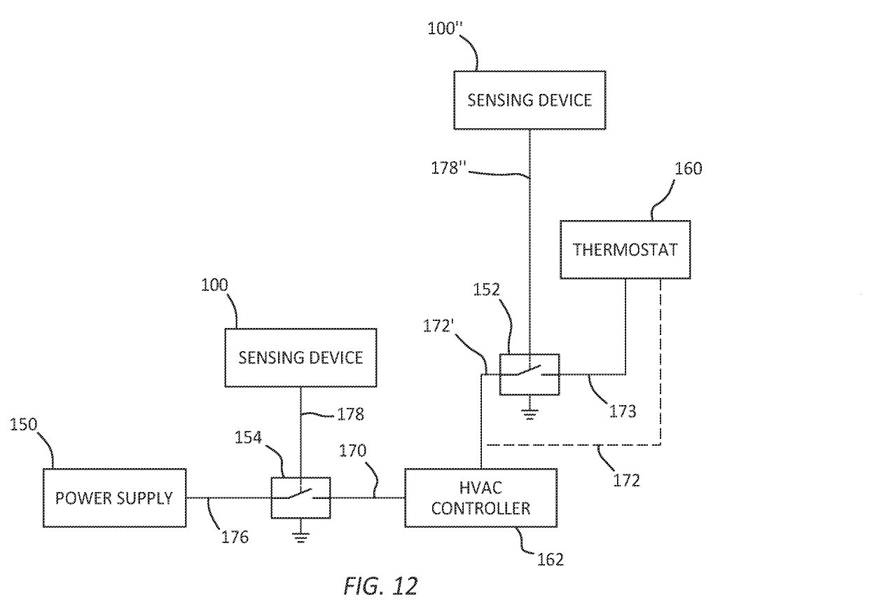

FIG. 12 is a representative functional block diagram of a sensing device 100 that can be used to monitor and manage a drainage system 12 for a dwelling place 10 and control an HVAC system 20 based on the indications from the sensing device 100. In a non-limiting embodiment, the dwelling place 10 can include a thermostat 160 used to control operation of the HVAC system 20 to maintain an interior of the dwelling place within an acceptable temperature range. In a non-limiting optional embodiment, the thermostat 160 can send a signal 172 to a controller 162 of the HVAC system 20 that it can turn on or off the HVAC system 20 to maintain the temperature in the interior. If the temperature becomes too low when in air conditioning mode, then the signal 172 can indicate to the HVAC system 20 to turn off, and if the temperature becomes too high, then the signal 172 can indicate to the HVAC system 20 to turn on.

A power supply 150 can supply power to the HVAC controller 162 via a signal 176. The current system can utilize a switch 154 to interrupt this signal 176 to force the HVAC system 20 to remain off or to be turned off, such as may be needed when a clog in the drain system is detected. The power supply 150, in the current system, can output a power signal 176 to power the HVAC controller 162, which can control the HVAC system 20. Therefore, if the switch 154 is closed, then power from the power supply 150 can be supplied to the HVAC controller 162 via the signal 176, the closed switch 154, and the signal 170. However, the switch 154 can be used to control power transmission to the HVAC controller 162 by enabling or disabling transmission of the signal 176 to the controller 162, via the signal 170 from the switch 154.

A sensing device 100 (e.g., sensing devices 100a, 100b, 100c) can be positioned to monitor a portion of the drainage system 12. An output signal 178 of the sensing device 100 can indicate whether an unacceptable level of fluid 50 is detected in a portion of the drainage system 12. If the level of fluid 50 is acceptable, then the output signal 178 can energize the switch 154 to a closed position such that the power signal 176 from a power supply 150 (e.g., a battery, utility power, etc.) can drive the signal 170 to power the HVAC controller 162. The power supply 150 can also be provided from the HVAC system 20 as +24 volts AC that is normally available and can easily be converted to 24 volts DC or any other suitable voltage needed for devices, such as +5 VDC.

With no clog detected by the sensing device 100, the power supply 150 can be allowed to power the HVAC controller 162 (i.e., output signal 178 energizes the switch 154 to remain closed) such that the power supply 150 powers the HVAC controller 162 which can then control the HVAC system 20 normally.

However, when the sensing device 100 detects that the fluid level in at least a portion of the drainage system 12 is at or above an unacceptable level, the sensing device 100 can deenergize, via the output signal 178, the switch 154 such that the signal 176 from the power supply 150 is no longer connected to the signal 170 to the HVAC controller 162, and the switch 154 can also connect the signal 170 to a ground reference to ensure that the HVAC controller 162 is not energized. By deenergizing the switch 154, the signal 176 can be disconnected from the signal 170, thereby deenergizing the HVAC controller 162.

When the sensing device 100 detects that the fluid level of the portion of the drainage system 12 is below the unacceptable level, then the output signal 178 can again energize the switch 154, which can then connect signal 176 to signal 170, thereby energizing the HVAC controller 162 allowing the HVAC controller 162 to again control the HVAC system 20. It should be understood that the sensing device 100 can be any of the sensing devices 100 (e.g., sensing devices 100a, 100b, 100c) described in this current disclosure.

Alternatively, in addition to, the thermostat 160 can send a signal 172’ to a controller 162 of the HVAC system 20 that it can turn on or off the HVAC system 20 to maintain the temperature in the interior. If the temperature becomes too low when in air conditioning mode, then the signal 172’ can indicate to the HVAC system 20 to turn off, and if the temperature becomes too high, then the signal 172’ can indicate to the HVAC system 20 to turn on. The thermostat can output a signal 173 that can be selectively coupled to the signal 172’ via switching on or off the switch 152. Therefore, if the switch 152 is closed, then the signal 173 from the Thermostat 160 can be supplied to the HVAC controller 162 via the signal 172’, the closed switch 152, and the signal 173. If the switch 152 is open, then the signal 173 from the Thermostat 160 is prevented from being transmitted to the HVAC controller 162, which can prevent the HVAC system 20 from being turned on. If the switch 152 is again closed, then the signal 173 from the Thermostat 160 can again control the Thermostat input into the HVAC controller 162.

A sensing device 100’’ (e.g., sensing devices 100a, 100b, 100c) can be positioned to monitor a portion of the drainage system 12. An output signal 178’’ of the sensing device 100’’ can indicate whether an unacceptable level of fluid 50 is detected in a portion of the drainage system 12. If the level of fluid 50 is acceptable, then the output signal 178’’ can energize the switch 152 to a closed position such that the signal 173 from the Thermostat can drive the signal 172 to the HVAC controller 162. With no clog detected by the sensing device 100’’, the Thermostat 160 can provide normal thermostat control of the HVAC system 20 via the HVAC controller 162 (i.e., output signal 178’’ energizes the switch 152 to remain closed) such that the Thermostat 160 transmits the signal 173 to the HVAC controller 162 which can then control the HVAC system 20 normally based on the Thermostat 160 output signal 173.

However, when the sensing device 100’’ detects that the fluid level in at least a portion of the drainage system 12 is at or above an unacceptable level, the sensing device 100’’ can deenergize, via the output signal 178’’, the switch 152 such that the signal 173 from the Thermostat 160 is no longer connected to the signal 172’ to the HVAC controller 162, and the switch 152 can also connect the signal 172’ to a ground reference to ensure that the HVAC controller 162 does not turn on the HVAC system. By deenergizing the switch 152, the signal 173 can be disconnected from the signal 172’, thereby indicating to the HVAC controller 162 to turn the HVAC system off.

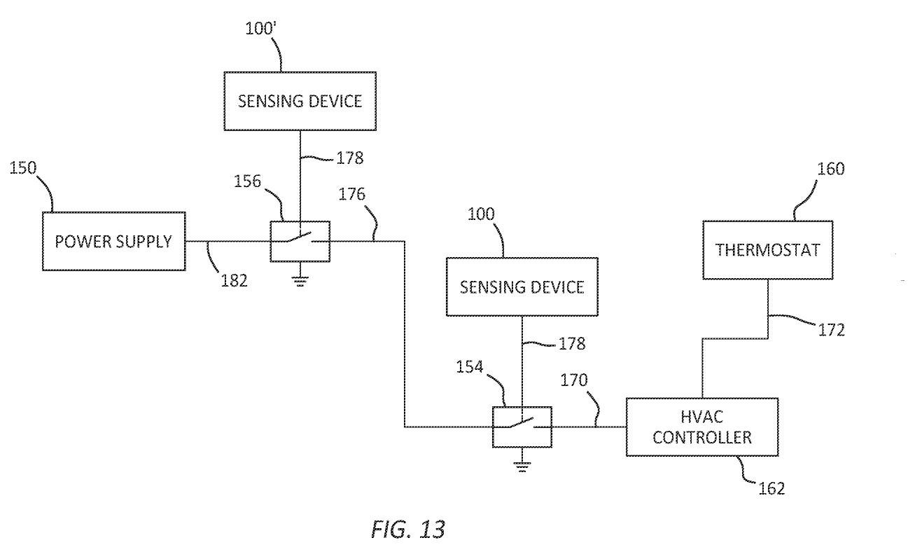

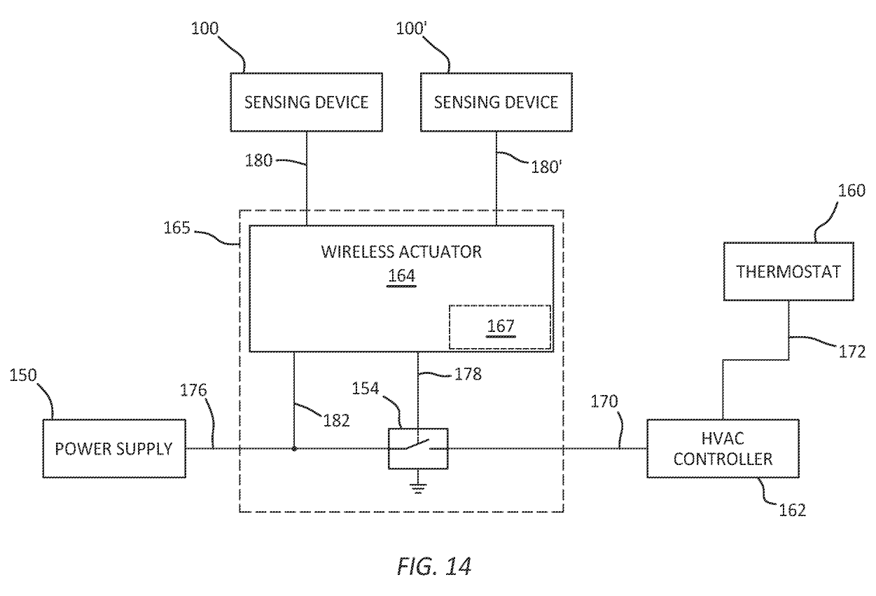

When the sensing device 100 detects that the fluid level of the portion of the drainage system 12 is below the unacceptable level, then the output signal 178’’ can again energize the switch 152, which can then connect signal 173 to signal 172’, thereby allowing the HVAC controller 162 to again control the HVAC system 20 normally based on the Thermostat 160. It should be understood that the sensing device 100’’ can be any of the sensing devices 100 (e.g., sensing devices 100a, 100b, 100c) described in this current disclosure. It should also be understood that the optional sensing device 100’’ (with the signal 178’’ and the switch 152) can be used to intercept the signal 172 from the Thermostat 160 to the HVAC controller 162 in any of the other configurations disclosed in this disclosure, such as illustrated in FIGS. 13 and 14.

FIG. 13 is a representative functional block diagram of sensing devices 100, 100’ being used to monitor and manage a drainage system 12 for a dwelling place 10 and control an HVAC system 20 based on the indications from the sensing devices 100, 100’. In a non-limiting embodiment, the dwelling place 10 can include a thermostat 160 used to control operation of the HVAC system 20 to maintain an interior of the dwelling place within an acceptable temperature range. The switch 154 can operate much the same as described above regarding FIG. 12, where the operation of the switch 154 via the output signal 178 controls whether or not the signal 176 is connected to the signal 170 to power the HVAC controller 162.

FIG. 13 is at least different from FIG. 12 in that two control switches 154, 156 are connected in series, such that when either one of the sensing devices 100, 100’ detects a clog (i.e., fluid level at or above an unacceptable level), then the power to the HVAC controller 162 can be removed which will disable the HVAC system 20.

A power signal 182 from the power supply 150 can be connected to the power signal 176 when the switch 156 is energized by the output signal 180 from the sensing device 100’. The power signal 176 can be connected to the signal 170 to energize the HVAC controller 162to enable normal operation of the HVAC system 20. If either one of the sensing devices 100, 100’ detects that a fluid level in a portion of the drainage system 12 is at or above an unacceptable level, then the corresponding switch 154, 156 can be deenergized, thereby disconnecting the signal 170 from the power signal 182 and causing the HVAC controller 162 to be deenergized and the HVAC system 20 turned off. It should be understood that the sensing devices 100, 100’ can be any of the sensing devices 100 (e.g., sensing devices 100a, 100b, 100c) described in this current disclosure.

FIG. 14 is a representative functional block diagram of sensing devices 100, 100’ that can be used to monitor and manage a drainage system 12 for a dwelling place 10 and control an HVAC system 20 based on the indications from the sensing devices 100, 100’. In a non-limiting embodiment, the dwelling place 10 can include a thermostat 160 used to control operation of the HVAC system 20 to maintain an interior of the dwelling place within an acceptable temperature range.

A power supply 150 can supply power to the HVAC controller 162 via a signal 176. The current system can utilize a switch 154 to interrupt this signal 176 to force the HVAC system 20 to remain off or to be turned off, such as may be needed when a clog in the drain system is detected. The power supply 150, in the current system, can output the power signal 176 to power the HVAC controller 162, which can control the HVAC system 20. Therefore, if the switch 154 is closed, then power from the power supply 150 can be supplied to the HVAC controller 162 via the signal 176, the closed switch 154, and the signal 170. However, the switch 154 can be used to control power transmission to the HVAC controller 162 by enabling or disabling transmission of the signal 176 to the controller 162, via the signal 170 from the switch 154.

Sensing devices 100, 100’ (e.g., sensing devices 100a, 100b, 100c) can be positioned to monitor a portion of the drainage system 12. They can be monitoring separate portions of the drainage system 12 or they can be monitoring the same portion the drainage system 12 with one being a primary sensor and the other being a backup sensor. An output signal 178 of the sensing device 100 and an output signal 178’ can indicate whether an unacceptable level of fluid 50 is detected in portion(s) of the drainage system 12.

If the level of fluid 50 monitored by the sensor 100 is acceptable, then the output signal 180 can be transmitted to the power controller 165 to indicate that no clog is detected by the sensor 100. If the level of fluid 50 monitored by the sensor 100’ is acceptable, then the output signal 180’ can be transmitted to the power controller 165 to indicate that no clog is detected by the sensor 100’. The power controller 165 can be used to control whether or not the signal 176 is connected to the signal 170 to power the HVAC controller 162. It can include the wireless actuator 164 with the antenna 167, and the switch 154.

The wireless actuator 164 can receive the signals 180, 180’ and energize the switch 154 to a closed position when neither signal 180, 180’ indicates a clog. The closed position enables the power signal 176 from a power supply 150 (e.g., a battery, utility power, etc.) to drive the signal 170 to power the HVAC controller 162. The power supply 150 can also be provided from the HVAC system 20 as +24 volts AC that is normally available and can easily be converted to 24 volts DC or any other suitable voltage needed for devices, such as +5 VDC.

With no clog detected by the sensing device 100, the power supply 150 can be allowed to power the HVAC controller 162 (i.e., output signal 178 energizes the switch 154 to remain closed) such that the power supply 150 powers the HVAC controller 162 which can then control the HVAC system 20 normally.

However, when either one of the sensing devices 100, 100’ detects that the fluid level in at least a portion of the drainage system 12 is at or above an unacceptable level, the wireless actuator can deenergize, via the output signal 178, the switch 154 such that the signal 176 from the power supply 150 is no longer connected to the signal 170 to the HVAC controller 162, and the switch 154 can also connect the signal 170 to a ground reference to ensure that the HVAC controller 162 is not energized. By deenergizing the switch 154, the signal 176 can be disconnected from the signal 170, thereby deenergizing the HVAC controller 162.

The wireless controller 164, via a wireless antenna 167, can wirelessly communicate to a user (e.g., via the internet, a cloud server, a cellular phone network, etc.) to alert the user that a clog has been detected. This wireless communication can also alert the user to which portion of the drainage system 12 is experiencing the clog.

When the sensing devices 100, 100’ both detect that the fluid level of the portion(s) of the drainage system 12 is below the unacceptable level, then the output signal 178 can again energize the switch 154, which can then connect signal 176 to signal 170, thereby energizing the HVAC controller 162 allowing the HVAC controller 162 to again control the HVAC system 20. It should be understood that the sensing devices 100, 100’ can be any of the sensing devices 100 (e.g., sensing devices 100a, 100b, 100c) described in this current disclosure.

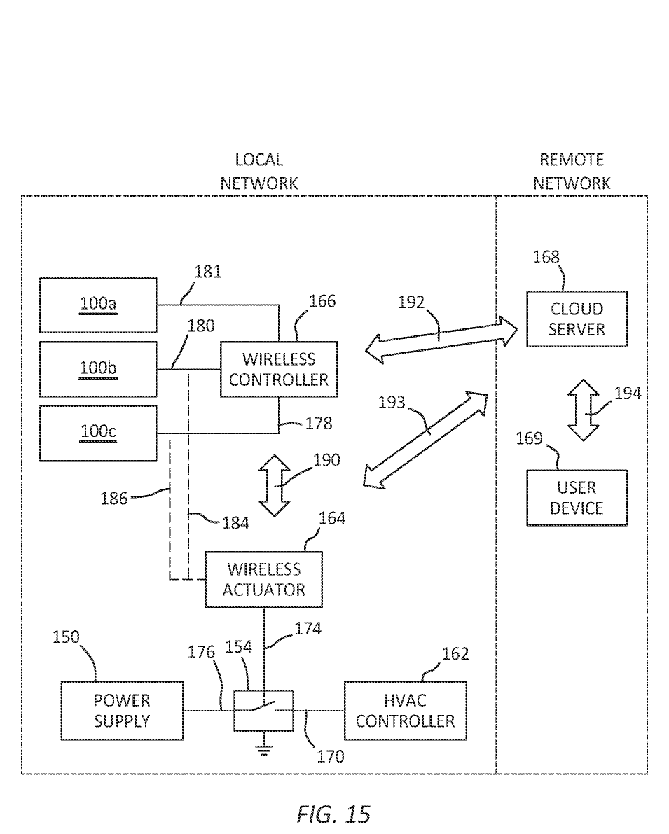

FIG. 15 is a representative functional block diagram of sensing devices 100a, 100b, 100c being used to monitor and manage a drainage system 12 for a dwelling place 10 and control an HVAC system 20 based on the indications from the sensing devices 100a, 100b, 100c. In a non-limiting embodiment, the sensing devices 100a, 100b, 100c can be equipped with wireless transceivers and can wirelessly communicate with other devices to enable or disable connection of the signal 176 to the signal 170, via a switch 154. It should be understood that more or fewer of the sensing devices 100a, 100b, 100c shown can be used in keeping with the principles of this disclosure.

The control line 174 that controls the switch 154 can be supplied by a wireless actuator 164 which can receive (via wired or wireless communication) indications from one or more of the sensing devices 100a, 100b, 100c. The sensing devices 100a, 100b, 100c can be positioned at various locations of the drainage system 12 (e.g., a sink drain 42, branch tailpiece 44, an HVAC drain line 60, an HVAC backup drain pan 64, etc.) to monitor the health of the drainage system 12. If any one of the sensing devices 100a, 100b, 100c detect an unacceptable level of fluid 50 in the drainage system 12, then they can communicate the indication to a wireless controller 166, which can wirelessly command the wireless actuator 164 (via the wireless communication link 190) to deenergize the switch 154 and disconnect the signal 176 from the signal 170. The wireless actuator 164 can also communicate directly via the wireless communication link 193 to a wireless network to alert the user of any indications of a clog.

The sensing devices 100a, 100b, 100c can communicate clog indications to the wireless controller 166 via the respective control signals 181, 180, 178 (which can be wired or wireless control signals). One or more of the sensing devices 100a, 100b, 100c (e.g., sensing devices 100b, 100c) can also be coupled to the wireless actuator 164 directly via the optional control signals 184, 186 (which can be wired or wireless control signals). Therefore, one or more of the sensing devices 100a, 100b, 100c can bypass the wireless controller 166 to deenergize the switch 154. In this case, the wireless actuator 164 can communicate (e.g., via communication link 190) to the wireless controller 166 that a clog has been detected and which of the sensing devices 100a, 100b, 100c indicated the clog.

The wireless controller 166 can also communicate via a communication link 192 to a cloud server 168 (or other wireless network) which can send alerts to a user device 169 via a communication link 194 (e.g., cellular network, internet, etc.). The user can be at a location that is remote from the dwelling place 10 or can be at the dwelling place 10 to receive the alerts. Upon receiving an alert, the user can possibly enable or disable smart systems in the dwelling place 10 via the communication link 194. For example, the user may send a command via the communication link 194 to a valve that can shutoff water to the entire dwelling place 10 or at least portions of the dwelling place 10 (e.g., supply lines to a sink 40, main supply to the dwelling place 10, etc.).

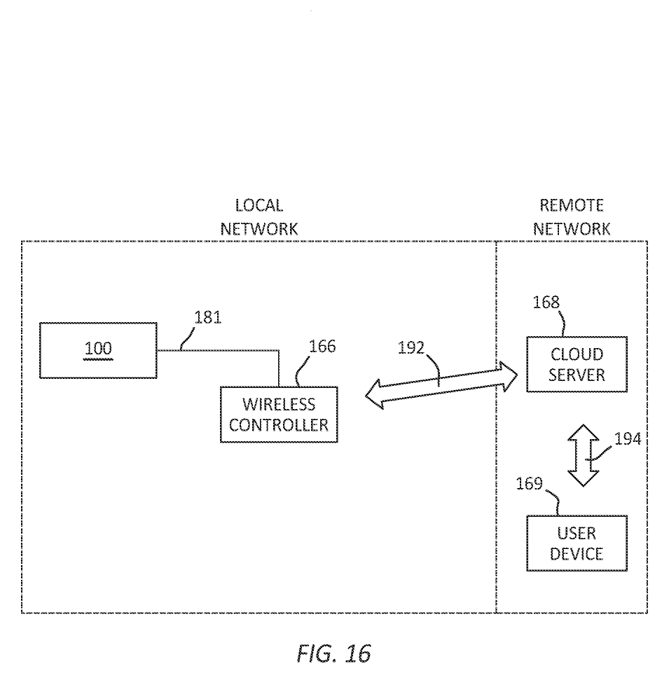

FIG. 16 is a representative functional block diagram of a sensing device 100 being used to monitor and manage a drainage system 12 for a dwelling place 10 and alert a controller or a user to the indications from the sensing device 100 whether a clog is present or not. In a non-limiting embodiment, the sensing device 100 can communicate, via either a wired or wireless communication link, with other devices to notify a user that can be within a local network (e.g., a local area network LAN in a dwelling place 10) or accessible via a network connection to a remote network. It should be understood that more sensing devices 100 can be used (e.g., to monitor multiple sink drains), in keeping with the principles of this disclosure.

The sensing device 100 can communicate clog indications to the wireless controller 166 via control signals 181 (which can be wired or wireless control signals). The wireless controller 166 can communicate via a communication link 192 to a cloud server 168 which can send an alert to a user device 169 via a communication link 194 (e.g., cellular network, internet, etc.). Upon receiving an alert, the user can possibly enable or disable smart systems in the dwelling place 10 via the communication link 194. For example, the user may send a command via the communication link 194 to a valve that can shutoff water to the entire dwelling place 10 or at least portions of the dwelling place 10 (e.g., supply lines to a sink 40, main supply to the dwelling place 10, etc.).

In any event, the sensing device 100 (e.g., sensing devices 100a, 100b, 100c) can be used to provide continuous monitoring of the performance of the drainage system 12 and provide early warnings or initiate early actions to mitigate damage that could have been caused by an unwanted clog in the drainage system 12.

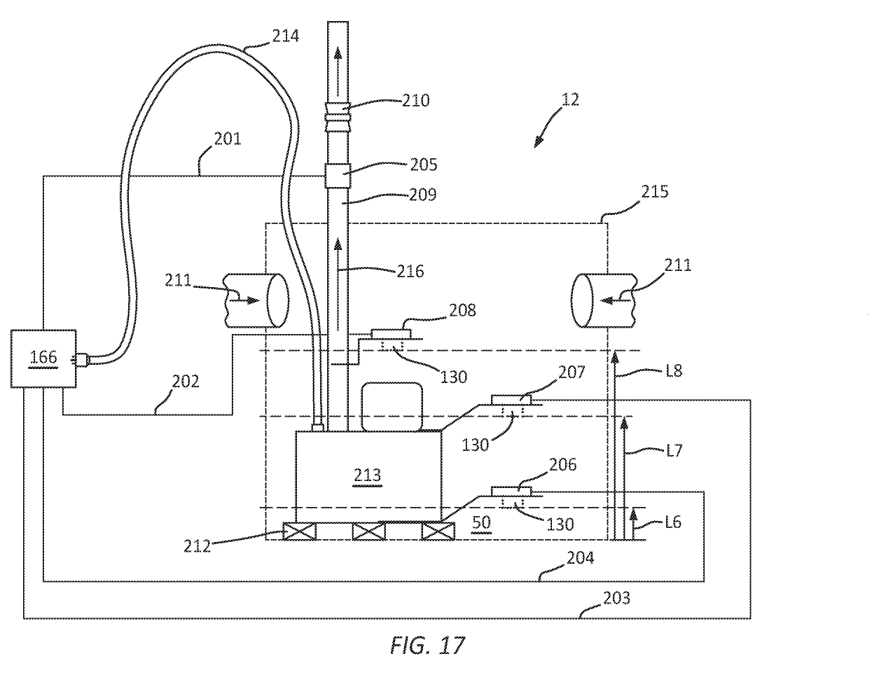

FIG. 17 is a representative partial cross-sectional view of sensing devices 205, 206, 207, 208 being used to monitor and manage a sump pump 213 operation in a drainage system 12 in a dwelling place 10, in accordance with certain embodiments. A sump pump 213 can be used to remove fluid 50 from a volume that is a destination point for draining the fluid 50 via gravity. The sump pump 213 can be utilized to suction up the fluid 50 in a collection housing 215 and pump the fluid 50 to a location in the drainage system 12 that is able to drain via gravity, such as an outdoor septic tank, a drain line within the dwelling place 10 that can drain via gravity, or to another pump station that can pump the fluid further away from the dwelling place 10.

The sump pump 213 is normally used to pump only when fluid is present and float switches may be used to indicate when fluid 50 is present and can turn the sump pump 213 on until the float switch again indicates that no fluid 50 (or not enough fluid 50) is present in the collection housing and will turn the sump pump off. However, these float switches are notoriously unreliable. A stuck float switch can inaccurately indicate that no fluid 50 is present if it is stuck open. Therefore, the faulty float switch may allow fluid 50 to build up in the housing 215 to a point that it overflows the housing and causes damage to the dwelling place 10.

Conversely, a stuck float switch can inaccurately indicate that fluid 50 is present if it is stuck closed. Therefore, the faulty float switch may turn the sump pump on even when no fluid is available which can eventually cause the sump pump 213 to fail since it is not intended to run dry.

The inventor of the current monitoring system has discovered a novel control system for monitoring and controlling a sump pump 213 using sensors, such as capacitive sensors, to detect the presence of fluid 50 at various levels in the housing 215. The capacitive sensors are more reliable than float sensors and can be submerged in fluid 50 without damage.

FIG. 17 shows a sump pump 213 in a housing 215 with multiple sensing devices 205, 206, 207, 208, which are communicatively coupled to a wireless controller 166. The wireless controller 166 can also provide power to the sump pump 213 via a power cord 214. The wireless controller 166 can receive data from each of the sensing devices 205, 206, 207, 208 and determine whether or not to turn the sump pump 213 on or off.

The sensing devices 205, 206, 207, 208 can be similar to any one or more of the sensing devices 100a. 100b, 100c. Therefore, in general, the discussion above regarding the sensing devices 100a. 100b, 100c are generally applicable to the sensing devices 205, 206, 207, 208 unless otherwise stated. In general, the sensing devices 205, 206, 207, 208 produce a sensing field 130 that extends outside of the body of the sensing devices 205, 206, 207, 208 and can be used to detect the presence of fluid within the sensing field 130.

The housing 215 can receive fluid 50 via one or more inlets 211 that are generally gravity fed drains. However, these drains can also be from another pump that is pumping fluid as the sump pump 213 does. The discharge pipe 209 is used to discharge fluid 216 from the housing 215 via the sump pump 213, when the sump pump 213 is turned on. A check valve 210 in the discharge pipe 209 can prevent discharged fluid 216 from returning to the housing once it has been pumped past the check valve 210.

The sensing device 205 can be mounted to a vertical discharge pipe 209 similar to the configurations shown in FIGS. 3A and 3B. If a fluid 50 is present in the discharge pipe 209 at the level of the sensing device 205, the controller 166 can determine, based on the indication from the sensing device 205 via the control line 201, that fluid 50 is being discharged from the sump pump 213 and can verify that the sump pump 213 is working at an appropriate time. If fluid 50 has reached the level of the sensing device 205 in the discharge pipe 209, but the sump pump 213 should be off (or not operating), then a problem can exist and a user can be alerted.

The sensing devices 206, 207, 208 can be used to detect various fluid levels within the housing 215. These sensing devices can be mounted similar to the mounting arrangement shown in FIG. 10. However, they should be mounted at varying heights from the floor of the housing 215. They can also be mounted on the outside of the housing 215 similar to FIGS. 3A and 3B and can detect the presence of fluid 50 through the housing wall. They would also be mounted at various heights to provide information about the operation of the sump pump 213.

The sensing device 206 can be mounted at a location that detects whether the fluid 50 is at or above the height L6. The sensing device 206 can indicate the presence of fluid at or above the height L6 to the wireless controller 166 via the control line 204. The sensing device 207 can be mounted at a location that detects whether the fluid 50 is at or above the height L7. The sensing device 207 can indicate the presence of fluid at or above the height L7 to the wireless controller 166 via the control line 203. The sensing device 208 can be mounted at a location that detects whether the fluid 50 is at or above the height L8. The sensing device 208 can indicate the presence of fluid at or above the height L8 to the wireless controller 166 via the control line 202.

If the fluid 50 in the housing 215 is below the height L6, then the wireless controller 166 can receive an indication from the sensing device 206 that no water is present in its sensing field 130. Therefore, the wireless controller 166 can turn the sump pump 213 off or leave it off based on the indication.

If the fluid 50 in the housing 215 is at or above the height L6, then the wireless controller 166 can receive an indication from the sensing device 206 that water is present in its sensing field 130. Therefore, the wireless controller 166 can turn the sump pump 213 on or leave it on based on the indication.

If the fluid 50 in the housing 215 is below the height L7, then the wireless controller 166 can receive an indication from the sensing device 207 that no water is present in its sensing field 130. If the sensing device 206 indicates the presence of fluid 50, then the controller 166 can determine that the sump pump 213 is probably working correctly, since the fluid has not reached the height of L7. If the sensing device 205 detects the presence of water in the discharge pipe 209, then this could further indicate that the sump pump 213 is working properly. The controller 166 also knows if it is sending a power signal to the sump pump 213 via the power cord 214 and can know whether or not the sump pump 213 should be operating.

If the fluid 50 in the housing 215 is at or above the height L7, then the wireless controller 166 can receive an indication from the sensing device 207 that water is present in its sensing field 130. If the sensing device 206 indicates the presence of fluid 50, then the controller 166 can determine that the sump pump 213 is probably not working correctly, since the fluid has reached the height of L7. If the sensing device 205 detects the presence of water in the discharge pipe 209, then this could further indicate that the sump pump 213 is working properly but the fluid 50 is not being properly removed from the housing 215. The controller 166 also knows if it is sending a power signal to the sump pump 213 via the power cord 214 and would know whether or not the sump pump 213 should be operating. At this point, the controller 166 can initiate an alert to the user or monitoring service that a failure has occurred and intervention is needed.

If the sensing device 205 does not detect the presence of water in the discharge pipe 209, then this could indicate that the sump pump 213 is not working properly assuming the controller 166 has sent a power signal to the sump pump 213 to be on. The controller 166 can send an alert to the use to indicate that the sump pump operation has failed for some reason and needs immediate action.

If the fluid 50 in the housing 215 is at or above the height L8, then the wireless controller 166 can receive an indication from the sensing device 208 that water is present in its sensing field 130. If the sensing device 206 indicates the presence of fluid 50, then the controller 166 can determine that the sump pump 213 is probably not working correctly, since the fluid has reached the height of L8 and that the problem has escalated in severity. If the sensing device 205 detects the presence of water in the discharge pipe 209, then this could further indicate that the sump pump 213 is working properly but the fluid 50 is not being properly removed from the housing 215. The controller 166 also knows if it is sending a power signal to the sump pump 213 via the power cord 214 and would know whether or not the sump pump 213 should be operating. At this point, the controller 166 can initiate an alert to the user or monitoring service that a failure has occurred and intervention is needed.

If the sensing device 205 does not detect the presence of water in the discharge pipe 209, then this could indicate that the sump pump 213 is not working properly assuming the controller 166 has sent a power signal to the sump pump 213 to be on. The controller 166 can send an alert to the use to indicate that the sump pump operation has failed for some reason and needs immediate action.

This monitoring system provides reliable monitoring of the fluid levels in the housing 215 and the operation of the sump pump 213.

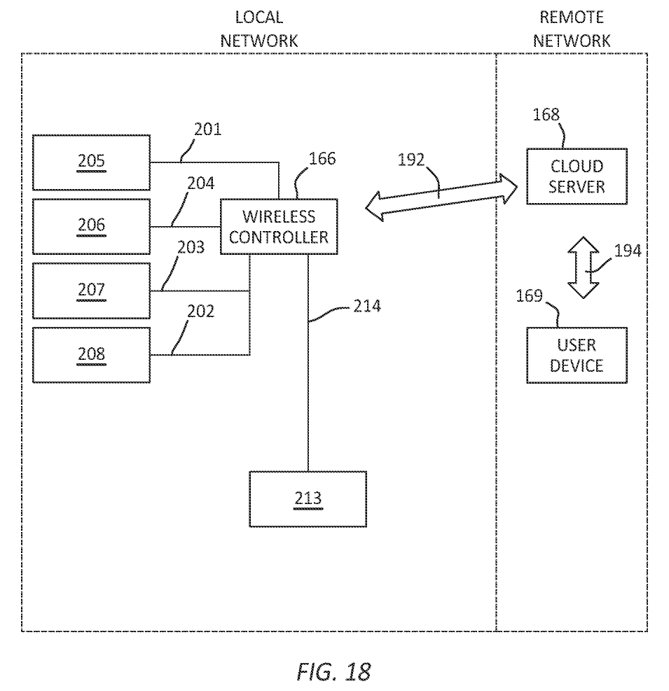

FIG. 18 is a representative functional block diagram of sensing devices being used to monitor and manage a sump pump operation in a drainage system in a dwelling place and notify a user based on the indications from the sensing device, in accordance with certain embodiments. The sensing devices 205, 206, 207, 208 can be communicative coupled to the wireless controller 166 via control lines 201, 202, 203, 204, respectively. It should be understood that the control lines 201, 202, 203, 204 can be either wired or wireless control paths.

Based on the indications received from the sensing devices 205, 206, 207, 208, the wireless controller 166 can determine whether or not to turn the sump pump 213 on or off. It can also use these sensing devices 205, 206, 207, 208 to determine, along with the state of the power cord 214, if a failure of the sump pump system has occurred.

The wireless controller 166 can communicate via a communication link 192 to a cloud server 168 which can send alerts to a user device 169 via a communication link 194 (e.g., cellular network, internet, etc.). The alerts can be various levels of severity depending on the failure that appears to have occurred. The user can be at a location that is remote from the dwelling place 10 or can be at the dwelling place 10 to receive the alerts. Upon receiving an alert, the user can possibly enable or disable smart systems in the dwelling place 10 via the communication link 194. For example, the user may send a command via the communication link 194 to a valve that can shutoff water to the entire dwelling place 10 or at least portions of the dwelling place 10 (e.g., supply lines to a sink 40, main supply to the dwelling place 10, etc.).

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, “generally”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

It should be noted that the X-Y-Z coordinate axes are indicated in at least FIGS. 1, 4A, 4B, 5A, 5B, and 6, where the X-Y-Z coordinate axes are relative to a level floor in the dwelling place 10. The floor forms an X-Y plane with the Z axis being substantially perpendicular with the floor. As used herein, “horizontal,” “horizontal position,” or “horizontal orientation” refers to a position that is substantially parallel with the X-Y plane. As used herein, “vertical,” “vertical position,” or “vertical orientation” refers to a position that is substantially perpendicular relative to the X-Y plane or substantially parallel with the Z axis.

### VARIOUS EMBODIMENTS

Embodiment 1. A sensing device, system and method, substantially as described above and/or depicted in the drawings.

Embodiment 2. A clog detection system and method, substantially as described above and/or depicted in the drawings.

Embodiment3. A clog detection system and method, in which a sensing device is removably attached to a branch tailpiece via a support structure, where the branch tailpiece comprises a main body with a first center axis and a branch with a second center axis, where the support structure aligns the sensing device parallel with the second center axis and aligns a sensing field of the sensing device with a plane formed by the first center axis and the second center axis.

Embodiment 4. A clog detection system and method, in which a sensing device detects fluid in an upper portion of a first drain line with the sensing device disposed outside the first drain line.

Embodiment 5. The clog detection system and method of embodiment 4, in which a body of the sensing device is disposed along a first plane that is parallel with a first center axis of the first drain line.

Embodiment 6. The clog detection system and method of embodiment 5, in which the first drain line is fluidically coupled to a second drain line with a second center axis, where the first center axis and the second center axis form a second plane, and where the first plane is perpendicular to the second plane.

Embodiment 7. The clog detection system and method of embodiment 6, in which the sensing device is attached to a support structure and the support structure orients the sensing device in the first plane and the second plane due to engagement of the support structure with the first and second drain lines.

Embodiment 8. The clog detection system and method of embodiment 7, in which the support structure engages a bottom of the first drain line and a side of the second drain line.

Embodiment 9. The clog detection system and method of embodiment 7, in which the support structure engages a top of the first drain line and a side of the second drain line.

Embodiment 10. The clog detection system and method of embodiment 7, in which the support structure is removably attached to the sensing device via one or more fasteners.

Embodiment 11. The clog detection system and method of embodiment 7, in which the support structure is removably attached to the first drain line via one or more fasteners.

Embodiment 12. The clog detection system and method of embodiment 7, in which the support structure is removably attached to the second drain line via one or more fasteners.

Embodiment 13. The clog detection system and method of embodiment 7, in which the first and second drain lines form a branch tailpiece where the second drain line forms a main body of the branch tailpiece and the first drain line forms a branch of the branch tailpiece.

Embodiment 14. The clog detection system and method of embodiment 13, in which detection of fluid in the upper portion of the first drain line or branch indicates a clog in a drainage system that is fluidically coupled to the first and second drain lines.

Embodiment 15. The clog detection system and method of embodiment 14, in which operation of a system that drains fluid into the first drain line or branch is halted in response to the detection.

Embodiment 16. The clog detection system and method of embodiment 14, in which notification of the detection is communicated to a controller or user to initiate corrective action.

Embodiment 17. A clog detection system and method, in which a sensing device detects an elevated level of fluid in a backup drain pan with the sensing device disposed on a support structure that is removably attached to a wall of the backup drain pan.

Embodiment 18. The clog detection system and method of embodiment 17, in which the detection of the elevated level of the fluid indicates that a clog in a drainage system that is fluidically coupled to the backup drain pan.

Embodiment 19. The clog detection system and method of embodiment 18, in which the sensing device detects the elevated level of the fluid via a contactless sensor that extends a sensing field downward from the contactless sensor through a portion of the support structure.

Embodiment 20. The clog detection system and method of embodiment 18, in which operation of a system that drains fluid into the backup drain pan is halted in response to the detection.

Embodiment 21. The clog detection system and method of embodiment 18, in which notification of the detection is communicated to a controller or user to initiate corrective action.

Embodiment 22. A sump pump system that comprises: a feedback system that provides fluid detection within the discharge pipe and a controller that is configured to determine operational status of the system based on the feedback.

Embodiment 23. The sump pump system of embodiment 22, wherein operation of a sump pump of the sump pump system is halted in response to an absence of a detection of a fluid in the sump pump system.

Embodiment 24. The sump pump system of embodiment 22, wherein a notification of an alarm or alert is communicated to a controller or user to initiate corrective action.

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub-combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A system for detecting a clog, the system comprising:
a sensor assembly comprising:
a sensing device; and
a support structure, wherein the support structure is configured to removably attach the sensing device to a branch of a branch tailpiece, wherein the branch tailpiece comprises the branch fluidically coupled to a main body, the branch having a first center axis and a first flow passage, and the main body having a second center axis and a second flow passage, wherein the sensor assembly is configured to engage the branch and the main body, and wherein engagement of the sensor assembly with the main body prevents rotation of the sensor assembly about the first center axis of the branch.

2. The system of claim 1, wherein the sensing device or the support structure engages the main body and prevents rotation of the sensor assembly about the first center axis of the branch.

3. The system of claim 1, wherein the support structure comprises protrusions that extend along opposite sides of the main body to engage the main body and prevent rotation of the sensor assembly about the first center axis of the branch.

4. The system of claim 1, wherein the sensing device or the support structure engages the main body and aligns a sensor of the sensing device with a plane formed by the first center axis of the branch and the second center axis of the main body.

5. The system of claim 1, wherein the sensing device comprises a sensor with a sensing field that extends into the first flow passage of the branch, and wherein the sensor is configured to detect when fluid in the first flow passage rises to a level such that the fluid is present in the sensing field.

6. The system of claim 5, further comprising:
a controller configured to receive a signal from the sensor, wherein the signal indicates when the fluid is present in the sensing field.

7. The system of claim 6, wherein the controller is integral with the sensing device.

8. The system of claim 6, wherein the controller is further configured to automatically initiate corrective action in response to when the signal indicates fluid is present in the sensing field.

9. The system of claim 8, wherein the corrective action comprises at least one of:
removal of power from a thermostat of a heating, ventilation, and air conditioning (HVAC) system; and
send an alert to a user device.

10. The system of claim 1, wherein the support structure engages a bottom of the branch and an outside surface of the main body.

11. The system of claim 10, wherein a fastener engages the main body and removably secures the sensor assembly to the main body.

12. The system of claim 1, wherein the support structure is disposed on an opposite side of the branch from the sensing device.

13. The system of claim 1, wherein the support structure is disposed on a same side of the branch as the sensing device.

14. A system for detecting a clog, the system comprising:
a sensor assembly comprising:
a sensing device; and
a support structure, wherein the support structure is configured to removably attach the sensing device to a wall of a drain pan, wherein the drain pan comprises an open top container with vertical sides and a drain line configured to drain fluid from the drain pan, wherein the sensing device is disposed within the drain pan and configured to detect when fluid rises to a predetermined level in the drain pan.

15. The system of claim 14, wherein the sensing device comprises a sensing field and the sensing device detects when fluid is present in the sensing field, the system further comprising a controller configured to receive a signal from the sensing device, wherein the signal indicates when the fluid is present in the sensing field.

16. The system of claim 14, wherein the open top container is a collection housing for a sump pump system, wherein a sump pump in the collection housing is energized based on when the fluid rises to the predetermined level and is deenergized when the fluid falls below the predetermine level, and wherein the sensing device comprises a sensor with a sensing field that extends from the sensing device, and the sensing device detects when fluid is present in the sensing field.

17. A system for detecting fluid level in a conduit, the system comprising:
a sensor assembly comprising:
a sensing device; and
a support structure, wherein the support structure is configured to removably attach the sensing device to a drain line having a center axis and a flow passage formed along the center axis, wherein when the support structure is removably attached to the sensing device, a bottom of the support structure engages a bottom of the drain line, a sensing field of the sensing device extends into a top of the drain line, and the support structure forms gaps between opposite sides of the drain line and respective opposite sides of the support structure.

18. The system of claim 17, wherein the gaps prevent a portion of the support structure from being positioned within the sensing field.

19. The system of claim 17, further comprising a controller configured to receive a signal from the sensing device, wherein the signal indicates when fluid is present in the sensing field, and wherein the controller is further configured to automatically initiate corrective action in response to when the signal indicates that fluid is present in the sensing field.

20. The system of claim 17, wherein the support structure is configured to prevent the sensing device from detecting the support structure in the sensing field.
